(19) United States
(12) Patent Application Publication
(10) Pub. No.: US 2004/0034683 A1
(43) Pub. Date: Feb. 19, 2004

(54) Differentiated transport services for enabling real-time distributed interactive virtual systems

(75) Inventor: Hui Zhao, Kanata (CA)

Correspondence Address: OGILVY RENAULT, 1981 MCGILL COLLEGE AVENUE, SUITE 1600, MONTREAL, QC, H3A2Y3, CA

(73) Assignee: UNIVERSITY OF OTTAWA, Ottawa (CA)

(21) Appl. No.: 10/216,833

(22) Filed: Aug. 13, 2002

(51) Int. Cl. G06F 15/16

(52) U.S. Cl. 709/201

(57) ABSTRACT

A middleware for providing differentiated network transport services to federates of a distributed interactive virtual system (DIVS) for supporting exchange of respective virtual objects and interactions, uses priority-based and/or signaling-based QoS mechanisms (one of which) available on current data networks. Federates of the DIVS maintain extended attribute and parameter tables that include a QoS tuple that specifies QoS properties that are used to select and effect data transport as required. Preferably priority-based preemptive scheduled processing of runtime interface tasks is performed to further improve a quality of the federate session so that substantially real-time processing is possible.

### CROSS-REFERENCE TO RELATED APPLICATIONS

This is the first application filed for the present invention.

### MICROFICHE APPENDIX

Not Applicable.

### TECHNICAL FIELD

The invention relates to interactive virtual systems, and in particular to methods and systems for enabling real-time distributed interactive simulation across a non-local data packet network.

### BACKGROUND OF THE INVENTION

Distributed interactive simulations (DIS) are systems of federates that individually and collectively model virtual objects and interactions between virtual objects in accordance with a standardized set of rules for how the federates exchange data and what kind of data is to be exchanged, etc. The demand for such systems can be found in many military and commercial applications. QoS demanding DIVS include military simulations, that require a scalable number of federates, and, for critical variables, transmission delays that are not perceptible at federate system interfaces. Federate system interfaces may include human interfaces, autonomous system interfaces, equipment interfaces etc. that all perform actions on the virtual objects, and expect consequences of these actions reflected in the states of the virtual objects of the DIVS. Some examples of DIVSs include: distributed interactive simulations; group training simulators; equipment test and verification simulations; remote interface and control systems (e.g. robot control systems, pilotless military vehicle systems, remote medical operations systems, etc.) and other heterogeneous virtual environments that implicate multi-vendor equipment, simulators, emulators, and resource bases to provide a realistic interactive representation space.

High level architecture (HLA) is a standardized framework for effecting the cooperation of respective federates to provide the virtual environment. The HLA standard does not provide details about how the federates are to effect delivery of session data. Runtime Infrastructure (RTI), an implementation of HLA, further provides general purpose transport mechanisms for the exchange of data, but unfortunately, no mechanisms are provided to handle a very important aspect of current distributed interactive virtual systems (DIVS): quality of service (QoS). QoS is required to maintain timing relationships between events and objects that interact or are jointly modeled by a plurality of federates.

Current HLA/RTI Standard DIVS

There are many different kinds of distributed interactive virtual systems that have different respective requirements for data exchange and computational services. In this document the following terms are used to describe DIVSS: a federate is any subsystem of the DIVS that maintains virtual objects and/or interactions between virtual objects of the DIVS. The “virtual objects” are any element of the representation space that may be expected to persist for a significant duration. The “interactions” are all other elements of the representation space that affect the virtual objects, and are initiated and controlled by respective federates at all times. These terms are generally consistent with terms defined by the high-level architecture (HLA) standard well known in the art, and it is with reference to the terms and assumptions of HLA, and more specifically, those of a standardized middleware RTI library, that the present invention is described.

FIG. 1 illustrates a plurality of federates 10, which perform simulation, emulation or otherwise contribute objects and/or interactions to the DIVS. The federates 10 are interconnected by a local area network 12, via RTI-provisioned middleware 14. It will be recognized by those of skill in the art that these federates may be running on different types of computers/computer systems, written in different programming languages. They may further use different representations of the virtual objects and interactions, and otherwise be dissimilar, except that they all conform to a set of the rules (such as the rules, interface specification, and object model template of HLA). Examples of such RTI middleware are known in the art.

It should also be noted that each RTI 14 may serve multiple federates concurrently, which may be run on the same computer/computing system, or may run on separate, collocated equipment. Further, in some embodiments, the same collocated equipment jointly serves as a federate of multiple federations.

An optional federation manager 16 is used in certain federations. The federation manager 16 has a respective RTI 14, and is adapted to perform a role that will be understood by those of skill in the art.

One important limitation on the deployment of real-time DIVS arises from data delivery requirements that are not easily met, unless the number of federates 10 is limited and the federates are all interconnected by a relatively small network that is managed or provisioned to handle quality of service requirements. Alternatively, end-to-end asynchronous transfer mode (ATM) networks may be used to interconnect geographically dispersed federates. ATM networks have been used to provide QoS required for DIVS using only signaling-based QoS mechanisms, which is expensive. Of course scalability is an issue when small networks are used, and the desire to employ geographically dispersed federates that do not happen to be positioned adjacent to ATM networks over which the federates may expect privileged service, cannot be satisfied in either of these cases. Current federations are not generally deployed across wide area data networks because of the degradation of the response to the federate interactions, and the cost of end-to-end ATM networks is prohibitive. Internet Protocol (IP) and Ethernet networks, on the other hand, are ubiquitous, but these networks are not generally adapted to provide the delivery guarantees required for real-time DIVS.

Resource and cost efficient transport management for communicating the data between federates is a prerequisite to deployment of large-scale DIVS. While networks can be designed to meet this need, and examples of QoS-enabled DISs have been developed using resource reservation protocol (RSVP) signaling-based QoS mechanisms over ATM networks, such implementations are expensive. There therefore exists a need for middleware for enabling QoS management of connection services so that federation delivery requirements can be met over public networks, and for enabling differentiated processing services to ensure that high priority processes are executed when required.

### SUMMARY OF THE INVENTION

It is therefore an object of the invention to provide a middleware for enabling a widely distributed real-time distributed interactive virtual system (DIVS) that is adapted to manage quality of service (QoS) for connection services, and provide differentiated computing and network services in dependence upon an importance of a variable being transported or computed.

In accordance with one aspect of the invention, a middleware containing a runtime infrastructure (RTI) library is extended to include: a QoS tuple that is added to each object class attribute, and to each interaction class. The middleware is further adapted to manage QoS requirements and leverage priority-based preemptive scheduled processing to ensure that higher priority processes get more computing resources than lower priority processes do, and that processor time is allotted to tasks in a balanced way.

The QoS tuple extension specify transport requirements and a task priority associated with respective object attributes and respective interactions. The task priority is used by a priority-based scheduled processor operating system that runs the middleware to provide differentiated access to the computer processing. The transport requirements indicate values used to set QoS features of a predefined QoS mechanism associated with each connection request by a configuration file, or other such programmed instruction. The transport requirements may include such QoS properties as latency, and an acceptable packet loss ratio, used to select a priority for the transport, and/or used for reservation of network resources. The transport requirements may further include values that indicate how much bandwidth is required and how much buffer memory is required to handle the transport. Further fine grain control over access networks may be provided.

A method for enabling real-time data exchange between federates of a wide-area distributed interactive virtual system, involves steps of extending an object class attribute table and an interaction class table associated with a runtime interface (RTI) middleware used to support the federate, by adding a QoS tuple to the respective tables, using the QoS tuple to establish a network data transport for respective ones of data variables published by the federate, and using the QoS tuple to set a priority for access to computational resources of priority-based preemptive scheduled computer operating system used to support the federate.

A method for providing a real-time distributed interactive virtual system (DIVS), involves associating a priority value with each variable maintained by a federate of the DIVS, using priority-based preemptive scheduled processing to provide differentiated access to computer processing time in accordance with the priority of the variable being processed and retrieving quality of service (QoS) descriptors associated with a class of each of the respective variables to provide differentiated access to transport services having respective QoS properties to transport data between federates in the DIVS.

### BRIEF DESCRIPTION OF THE DRAWINGS

Further features and advantages of the present invention will become apparent from the following detailed description, taken in combination with the appended drawings, in which:

FIG. 1 schematically illustrates a prior art system for providing a distributed interactive virtual system;

FIG. 2 schematically illustrates a system for providing a distributed interactive virtual system in accordance with the invention;

FIG. 3 schematically illustrates middleware adapted to perform QoS management and data transmission exchange, in accordance with the invention;

FIG. 4 schematically illustrates an example of a priority-based preemptive scheduled processing system that may be used in accordance with an aspect of the invention;

FIG. 5 illustrates principal steps involved in providing a network QoS managed channel in accordance with the present invention; and

FIG. 6 schematically illustrates an example of a network in which the present invention may be deployed.

It will be noted that throughout the appended drawings, like features are identified by like reference numerals.

### DETAILED DESCRIPTION OF THE PREFERRED EMBODIMENT

The invention enables real-time distributed interactive virtual systems (DIVS). Real-time response may be achieved by leveraging network quality of service (QoS) features used to effect resource-efficient and cost-efficient transport services, while maintaining timeliness and reliability delivery constraints combined with differentiated access to computation services. In particular, judicious use of a plurality of QoS mechanisms, including currently available signaling-based and priority-based QOS mechanisms, provides cost and resource efficiency. Further efficiencies are provided by specifying QoS properties such as dedicated/aggregatable transport, and a priority value for each variable that is to be exchanged between federates of the DIVS. Preferably the federate processors provide tasks/threads/processes with differentiated access to computation services, according to a priority associated with each task/thread. The differentiated computation and transport services are used to provide real-time interaction between federates of the DIVS.

DIVS Requirements

There are many different kinds of distributed interactive virtual systems that have different respective requirements for data exchange and computational services. In this document the following terms are used to describe DIVSs: a federate is any subsystem of the DIVS that maintains virtual objects and/or interactions between virtual objects of the DIVS. The “virtual objects” are any element of the representation space that may be expected to persist for a significant duration. The “interactions” are all other elements of the representation space that affect the virtual objects, and are initiated and controlled by respective federates at all times. These terms are generally consistent with terms defined by the high-level architecture (HLA) standard well known in the art, and it is with reference to the terms and assumptions of HLA, and more specifically, those of a standardized middleware RTI library, that the present invention is described.

As described above, data delivery requirements for real-time DIVS are not easily met, unless the federates 10 are all interconnected by a relatively small network, or an asynchronous transfer mode (ATM) network is used from end-to-end. Signaling-based QoS mechanisms have been known to meet delivery requirements for DIVS, at a high cost. Enabling Internet Protocol (IP) and Ethernet access networks, and core networks that are not specifically designed for the DIVS is now possible using the present invention.

The basic requirements for DIVS include real-time delivery of critical data and differentiated processing of the data when computer processor resources are limited. Generally different treatment is required for different data. For example, three kinds of transport are used in the RTI standard: a “reliable” unicast; “low-latency” unicast and a “low-latency” multicast.

Reliable unicast transport can easily be provided with a transport control protocol (TCP). Reliability here implies a bounded protocol data unit loss ratio that ensures that substantially all protocol data units are (eventually) received at the destination RTI 14. As is known in the art, IP networks are prone to lose packets, but this limitation is largely overcome by acknowledging receipt of packets, in a manner well known in the art. Unfortunately this acknowledgement method slows delivery considerably, and is not available for multicast channels. Reliable unicast channels are particularly important for the exchange of control information between RTIs 14, when the control information does not immediately impact processing performed by a federate. Reliable multicast transport can be provided using a plurality of reliable unicast connections.

As is well known in the art, multicast transport can be setup using user datagram protocol (UDP)/IP to provide a lower latency transmission than is possible using TCP/IP. This solution may therefore be adequate for low-reliability transport when reduced latency is required, especially when the data to be conveyed is of a fine granularity, requiring little packetization and sequencing. Unfortunately no latency guarantees are provided for UDP packets, and so this type of transport is frequently not acceptable to DIVS that require bounded latency. As will be appreciated by those skilled in the art, this type of transport is particularly applicable to streaming data of constantly changing variables, such as position of a mobile virtual object, etc., for which an occasionally lost variable does not adversely affect the system, and for which the usefulness of the variable in an occasionally lost or late datagram protocol data unit expires as soon as a next protocol data unit is received.

There are several other kinds of data transport that are equally important to many DIVS. For example, low-latency, reliable multicast transport of “bursty” traffic is of great importance for many interactions that need to be processed in a timely manner by all RTIs 14. Such traffic cannot be handled well by either of the transport options described above. Moreover, reliable multicast transport may be important for broadly disseminated data such as virtual environment information (weather, terrain, etc.).

In addition, low-latency reliable unicast transport may be required to permit communication of interactions that are localized to only two elements, for example. These types of data delivery requirements have been determined by prior analysis, and are known in the art. For example, the Internet engineering task force (IETF) request for comments (RFC) 2502 of February, 1999, entitled Limitations of Internet Protocol Suite for Distributed Simulation in the Large Multicast Environment, discusses these requirements. Five different types of data transport important for DIVS are summarized below in Table 1.

TABLE 1
Transport Types

| | | Protocol | |
|---|---|---|---|
| | | data unit | |
| Transport Type | Latency | Loss | Distribution |
| 1. Control info | Typical | Reliable | Unicast |
| 2. Continuous change | Low | Best-effort | Multicast |
| 3. General event | Low | Reliable | Multicast |
| 4. Background data | Typical | Reliable | Multicast |
| 5. Localized event | Low | Reliable | Unicast |

While no single communication service can provide all of these transport types, each of these can be provided within required QoS over current data networks that provide priority-based and/or signaling-based QoS mechanisms. All current Ethernet networks, and substantially all IP networks, support QoS mechanisms required to provide these data transport services.

Other concerns that have been identified regarding transport services to support DIVS include scalability and granularity. Scalability can be improved by using coarse-grained QoS mechanisms (such as multi-protocol label switching (MPLS), and differentiated service, well known in the art) for transport of data over backbone networks, while using QoS techniques such as integrated service for fine-grain control. Usually the fine-grain control is provided locally, while the network transport mechanisms are provided by a network service provider who provides guarantees of differentiated priority-based transport services at respective costs. Mapping fine-grained QoS mechanisms to other priority-based QoS mechanisms is known in the art. For example the Internet engineering task force (IETF) working group integrated services over specific link layers (ISSLL) is standardizing a mapping from integrated services to ATM, Ethernet, and differentiated service networks. Almost all network equipment vendors support these mappings. For example, Cisco's feature “RSVP Scalability Enhancement” supports RSVP mapping to differentiated services. The fine-grain control provides a mechanism for grouping flows or conversations together. This can be used to provide RTIs 14 with a bandwidth-sharing capacity that is particularly useful for accommodating many conversations or flows that require substantially the same QoS treatment with fewer reserved resources than a sum of all of the transport together.

It should also be noted that priority-based preemptive scheduled processing techniques that are well known in the art and are currently supported (in several different ways) by all major operating systems. These techniques need to be efficiently used to ensure priority is given to processing critical variables, if allocation of computer processor time is relevant to the federation session.

System Overview

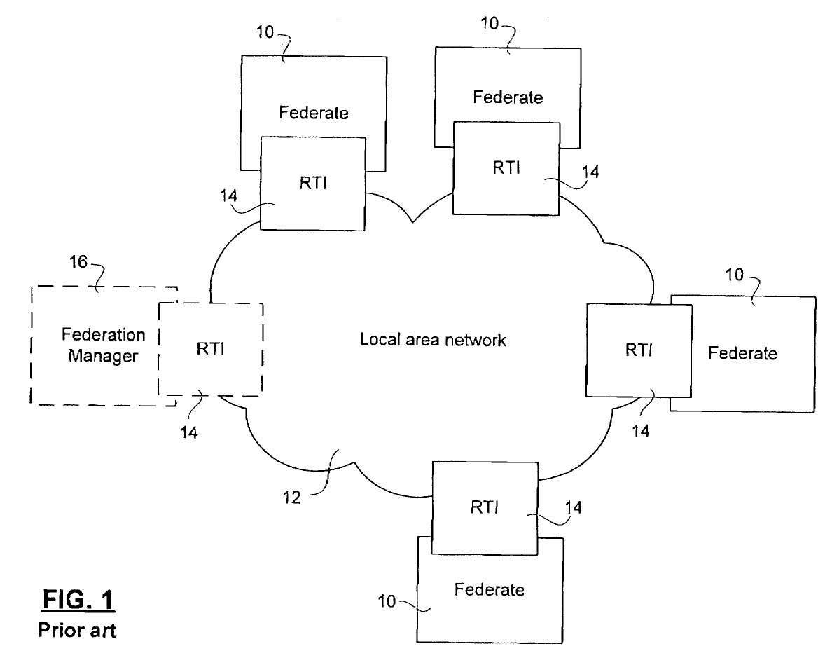

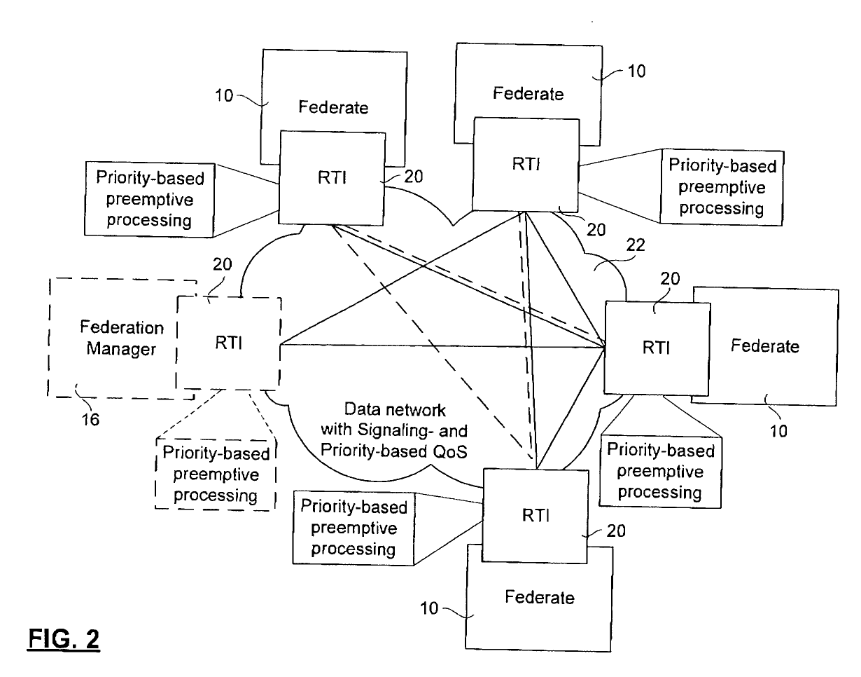

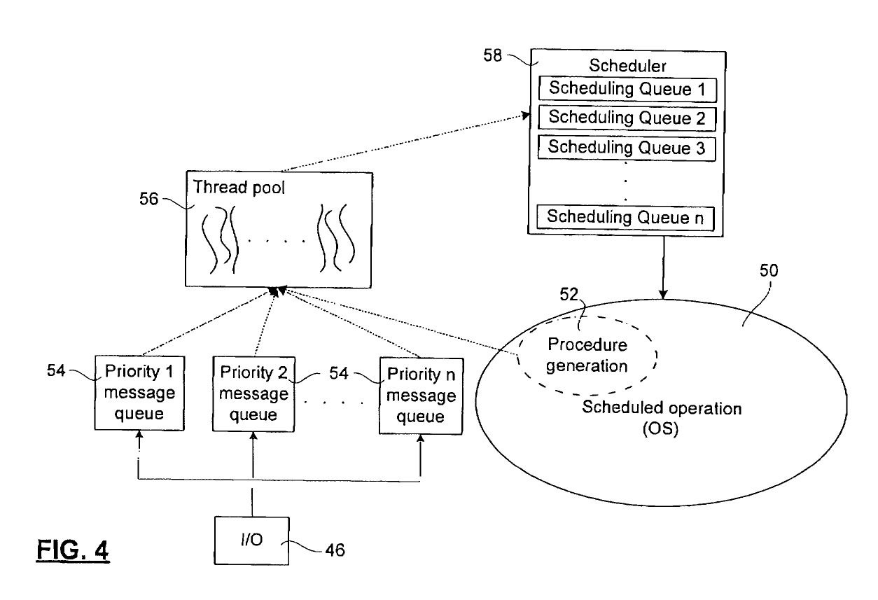

A system in accordance with the invention is illustrated in FIG. 2. The federates 10 and optional federate manager 16 are similar to those described with reference to FIG. 1. This is advantageous, as expensive simulators, emulators, etc do not have to be modified to be operative in a DIVS in accordance with the invention. Consequently, a system in accordance with the invention is backwards compatible with current standard RTI embodiments. RTI middleware 20 in accordance with the invention has access to an extended RTI library. The RTI middleware 20 is run on an operating system that provides priority-based preemptive scheduled processing. As is well known in the art, scheduled processing may be performed using threads, procedures, or tasks, depending on the operating system employed. The RTI library provides a priority value for each thread, procedure or task, in dependence on a measure of criticality. The criticality is preferably associated with a variable (an attribute of a virtual object, or an interaction), although some threads, tasks and procedures may be assigned priority values independently of a virtual objects or interactions. The criticality is therefore associated with an importance of the function or an associated thread, task or procedure, in a manner known in the art. A particular example of a priority-based operating system for providing preemptive scheduled processing of DIVS data is described below with reference to FIG. 4.

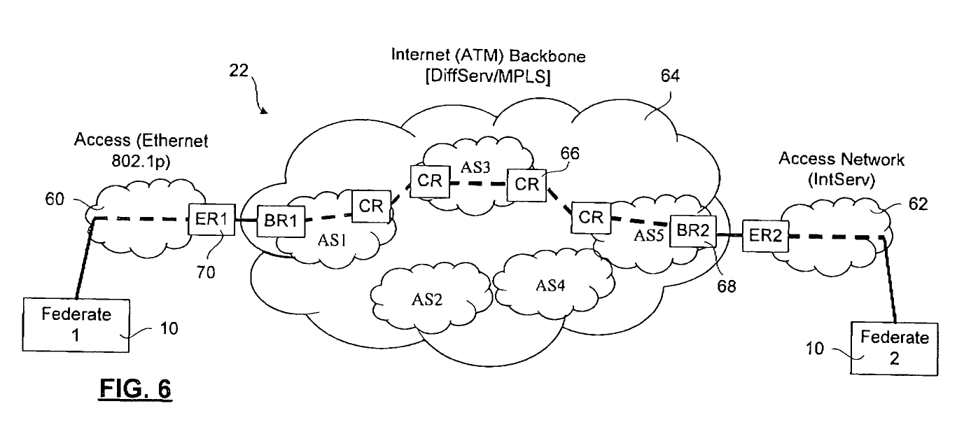

A network 22 enabled to provide signaling-based and priority-based QoS mechanisms to each of the RTI middlewares 20, in accordance with the invention may span a wide area. Typically the data network 22 includes a core of many independently managed autonomous subnetworks called a backbone, or a network core (often IP or ATM), and a plurality of access networks on the periphery. In accordance with the invention, each of the RTI middlewares 20 that is capable of publishing a variable, has entered into a service level agreement (SLA) with a network service provider (NSP) to provide transport services using selected signaling-based and/or priority-based QoS mechanisms. An example of a currently available network 22 in which the invention can be deployed is described below in more detail, with reference to FIG. 6.

Federation Tables

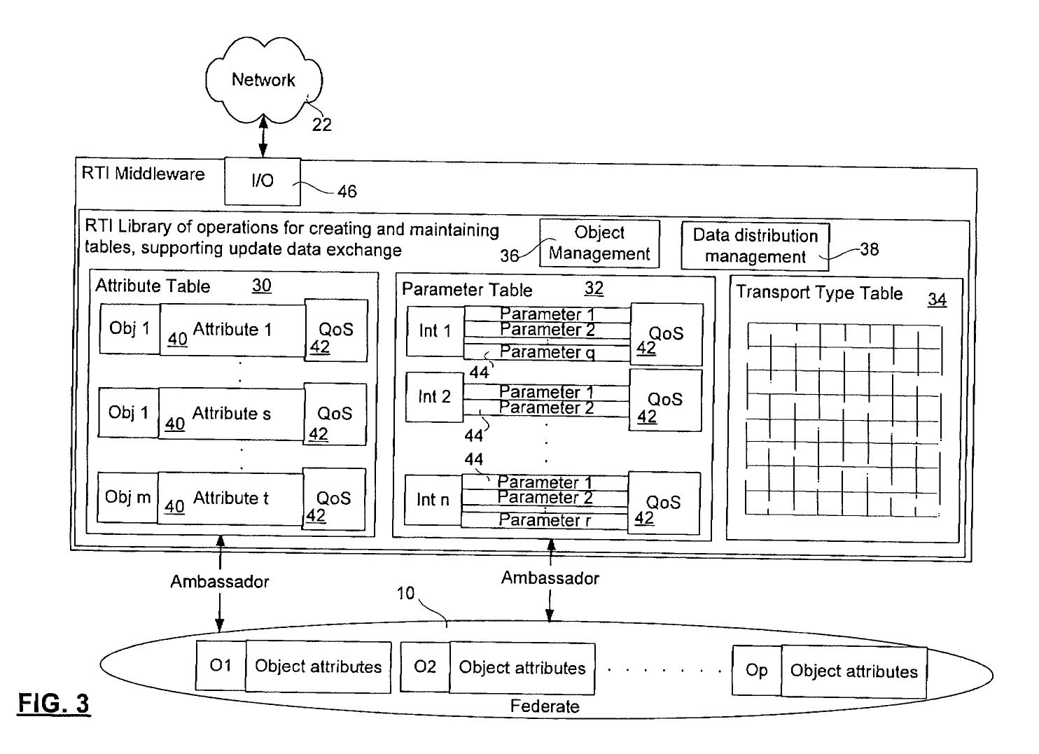

FIG. 3 schematically illustrates principal elements of RTI middleware 20 in accordance with the invention. As is well known in the art, creating a federation in accordance with HLA, involves creating a plurality of static tables, including a federation object model (FOM), and, for each federate, a simulation object model (SOM). Each of the federation and simulation object models includes an object identification table, and object and interaction class structure tables that define relationships between the classes of the virtual objects and relationships between the interaction classes, respectively. The RTI library, in accordance with the HLA standard, further includes an attribute table 30, a parameter table 32 and a transport table 34. Object management 36 and data distribution management 38 resources are also included in the RTI library with other resources that are used at run time.

The attribute table 30 comprises a plurality of attribute tuples 40 in accordance with the present HLA standard. Each of the attribute tuples 40 includes an identifier of an object class (obj 1−m) that the attribute tuple 40 qualifies. This attribute tuple 40, in accordance with the current standard, is constitutive of the attribute, just as the set of attributes that qualify an object are constitutive of the object class. In accordance with the present invention however, an additional set of quality assurance columns are added to the attribute table. The quality assurance columns provide space for a QoS tuple 42 for each attribute. The QoS tuple 42 specifies an importance of the attribute variable for the federation, and is determinative of how a variable of the attribute of an instantiated virtual object will be processed at run time.

Similarly, parameter table 32 is modified to include QoS tuples 42. Each parameter tuple 44 is associated with an interaction that it qualifies. However, while object class attributes are independently published and subscribed to, only complete interaction classes are subscribed to and published. Consequently fewer values are needed to specify a parameter than are available for specifying an object attribute. Furthermore, the QoS tuples 42 in the parameter table 32 are bound to interactions (Int 1 . . . n), and not to individual interaction parameters.

The transport type table in accordance with the current standard provides two different types of data transport. This is insufficient, and the five types that have been suggested are supported by the RTI middlewre 20, in accordance with the present invention.

Each type of virtual object (Obj 1 . . . m) that may be published by the federate 10 in the course of a federation session is defined by the plurality of attributes that are maintained by the federate. Each virtual object in the federation is an instance of one of the object classes (Obj 1−m), and is defined by current values of variables of the respective attributes. Similarly each interaction that can be exchanged within the federation is an instance of one of these interaction classes, and is defined by values of variables of the parameters. While the federates have particular objects, entities, conditions having various status variables etc. that may or may not be coterminous with the virtual objects or their respective attributes, an ambassador function well known in the art, is adapted to interpret the status variables etc. of the federate, and maintain published attributes of instantiated objects of the respective object classes, throughout the respective lives of the instantiated objects. The virtual objects are instantiated, maintained, and destroyed by the object management resources 36, and the network transport used to support the exchange of variables of the attributes are controlled by the data distribution management resources 38.

The virtual objects, the object presented to the other federates, in contrast with the federate objects, are defined by the set of attributes (for example, Obj 1 has attributes 1 . . . s)), each of which are specified by a predefined set of properties that include: a name of the object; a name of the attribute; a data type of the attribute; etc. as the standard defines. Of course the existing standards do not support all of the previously defined transport service types, nor do they permit specification of transport service properties such as granularity, latency, reliability, security, and data that can be used for network resource reservation. These properties are added to the RTI middleware 20 in accordance with the invention. In order to provide well discriminated transport services for each conversation and flow between federates, the quality assurance columns are added to the standard attribute table. An example of a set of quality assurance columns that provide QoS tuples in accordance with the invention is shown in table 2.

TABLE 2
Quality assurance columns
Average rate
Max. rate
Burst duration
Maximum delay
Loss ratio
Task priority
Packet priority
Aggregatable/Dedicated
Security

A QoS tuple is sufficient to specify network and processor QoS to permit substantially real-time services using current and emerging network QoS mechanisms, and priority-based preemptive scheduled processing using current and emerging operating systems.

The average rate represents an average data rate required to support delivery of a variable (of an interaction or object attribute). The average rate may be calculated by multiplying an (average) number of bits in the data type, by a (average) frequency of the update, or it may be determined empirically.

The maximum rate is a data rate required to support delivery of the variable when a maximum number of bits in the data type are updated at a maximum rate. The maximum rate will differ most widely from the average rate when the number of bits in the data type varies most widely, and the update condition occurs sporadically.

The burst duration is a maximum length of time throughout which the data rate required to support the delivery exceeds the average rate.

The maximum delay is a maximum length of time for transporting the data. This can be measured using a number of known techniques, including off-the-shelf software.

The loss ratio is a number of protocol data units lost per million protocol data units sent.

These first 5 new values will be immediately recognized by those skilled in the art as values supplied for most signaling-based QoS mechanisms, such as RSVP. The maximum value is used to determine a bandwidth required to support the delivery of the variable, at network equipment that supports RSVP. This equipment includes ATM network equipment, and most edge network equipment, but does not include most of the Internet backbone. The maximum rate and burst duration are used to determine an amount of buffer storage that needs to be reserved at edge network equipment to ensure that if the average data rate is exceeded, a backlog of data is not overwritten before the burst duration has expired, by which time the volume of data is expected to have abated. The loss ratio is also specified to determine a quality of service for the transport.

The task priority is used by operating systems to ensure that threads, tasks or processes that have a high priority have greater access to computer processor time than do lower priority threads, tasks or processes.

The packet priority is used to assign a (usually 3-bit) priority value to a protocol data unit transmitting the variable, and are used for IP routing of protocol data units throughout the IP network, in accordance with priority-based QoS mechanisms, such as differentiated service and MPLS.

The aggregatable/dedicated indicator can be used to assert that identified variables need to be communicated in isolation from other variables. As most signaling-based QoS mechanisms permit users to establish many channels that can be used separately, or can be aggregated by common features (such as destination address and port number) This feature is useful for enabling fine-grain transport service control, in a manner known in the art.

A final element of the RTI middleware 20 is a logical input/output port 46 through which the variables are sent into the network 22, and variables are received from the network 22. As will be recognized by those of skill in the art, any port number can be used subject to provisioned limitations of the port, in a manner well known in the art.

Interpretation of Table

After all of the object model tables have been created, and a set of network QoS solutions have been selected for a federation session, the session may begin. Each of the RTI threads, tasks, or processes are assumed to be associated with task priority values of an associated attribute or interaction. If no attribute or interaction is directly or indirectly associated with a thread, task, or process, its importance to the RTI can be used to assign the priority by the program that generated the thread, or a rule for the association can be encoded. As will be appreciated by those skilled in the art, there are a great number of ways to accomplish this association.

FIG. 4 schematically illustrates an embodiment of a multi-thread operating system (OS) that can be efficiently used to implement the invention. When a scheduled operation of a thread executes at the processor performing scheduled operations 50, a task may be defined that is performed by procedure generation module 52. The task, in accordance with an embodiment of the invention contains a task priority value derived from the static attribute table. The identification of a new task prompts the generation of a task identifier, which is assigned to a thread in a thread pool 56. Of course other message queuing procedures known in the art can also be used.

Given the quantity of variables that are communicated over a network during a federation session, it is preferable that a special mechanism is put in place to facilitate the priority-based preemptive processing of these variables with dispatch. Accordingly, in accordance with the present embodiment a set of priority message queues 54 are used to indicate protocol data units received at I/O port 46. Priority message queues 54 are used to provide time-of-receipt ordered queues for holding references to the protocol data units in accordance with a task priority of the variable the protocol data unit contains, until a thread is assigned to the reference. Alternatively, the priority assigned to the priority message queues 54 may correspond with packet priority values of the protocol data units. When a reference reaches a top of the message queue, it is assigned a thread in the thread pool 56. The thread assignment can follow any of the known techniques that permit preferential assignment, in accordance with the priority of the message queue.

Preferably the thread pool 56 established prior to the commencement of the session is provided for all RTI processing, although this is not absolutely necessary. Current practice uses one or two threads for the RTI processing, but it is clear that this does not generally provide adequate computer processor resource allocation to permit the kind of differentiated handling of the RTI processing that is needed in computer resource limited implementations of the invention. Creating the thread pool 56 in advance significantly improves a rate of processing in many instances.

After a thread has been assigned to the task, it is scheduled for execution by the scheduler 58. The thread is executed when scheduled in accordance with a preemptive priority-based scheduling algorithm that is known in the art.

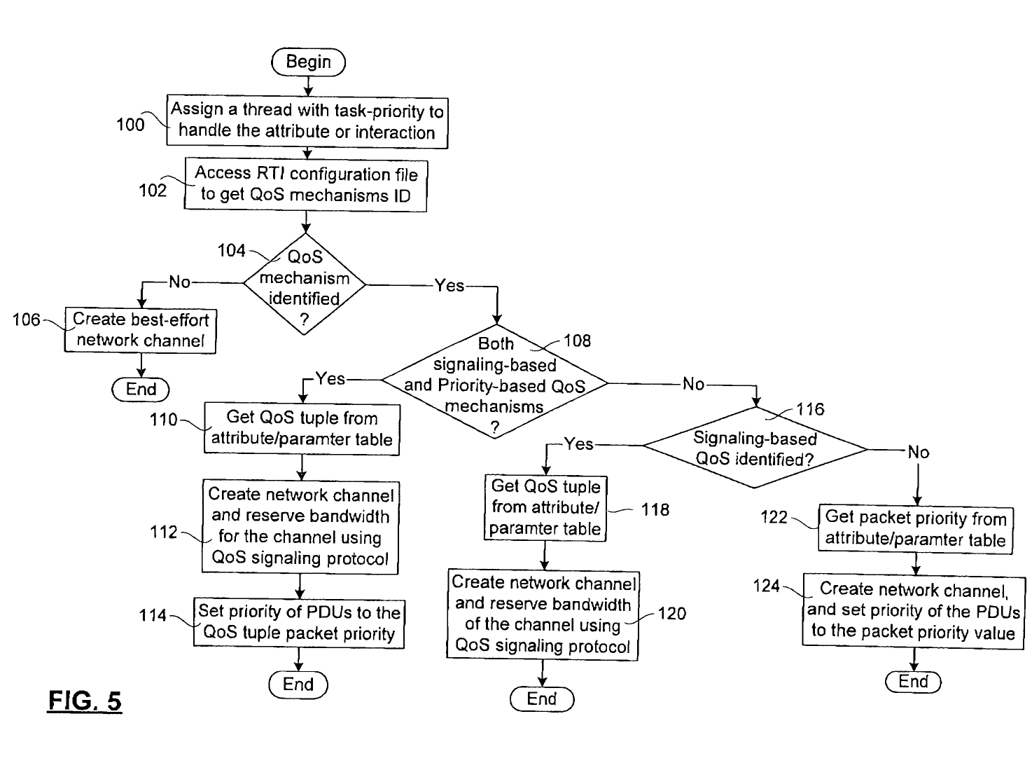

In conformance with the RTI standard, when an object or interaction is instantiated at the federate 10 (of FIG. 2), and attributes are published, other federate RTI middleware is able to subscribe to the published attributes class or interaction class. If one or more federates are within the scope of the instantiated object, or the interaction, and subscribe to the associated class, the data distribution management 38 (of FIG. 3) issues the object to the one or more federates, in a manner known in the art. Principal steps involved in creating a channel to support the exchange of a variable are illustrated in FIG. 5.

In step 100, a thread is assigned to the creation of the channel. A priority value of the thread is assigned to be that of the variable for which the channel is being provided. A configuration file is accessed to determine the selected QoS mechanisms to be used to support the exchange of the variable (step 102).

If it is determined in step 104 that no QoS mechanisms are in place, or that the specific channel does not require QoS management, a best-effort transport is created, if one is not already established (step 106) using TCP or UDP. As will be apparent to those of skill in the art, if the loss ratio in the QoS tuple associated with the variable is below a certain threshold, the transport layer TCP will be used to create the transport, and the transport will be unicast. The transport will be a best-effort type of service that has no service guarantee as regards timely delivery. If latency is more important than reliability, UDP is used. As is well known in the art, in most systems a plurality of application programming interfaces (APIs) are used to create the transport, and these APIs, are able to assign different kinds of QoS features to the transport using the QoS parameters. Examples of such APIs are included in most current operating systems. For example, sockets are created using Unix APIs.

Otherwise some QoS mechanism is available for the channel. It is first determined (in step 108) if both signaling-based and priority-based QoS mechanisms are available. If they are, the values in the QoS tuple of the variable associated with one of an object's attribute and an interaction, are retrieved (step 110), a network channel is created (step 112), and the packet priority in the QoS tuple is set for the channel, so that every protocol data unit sent through the channel is assigned the packet priority.

The step 112 of creating a transport generally entails using a set of APIs that include commands for loading the values of the QoS tuple and using these to assign network resources accordingly. Because both priority-based and signaling-based QoS mechanisms are used, there is no need for edge equipment to map the signaling-based QoS values to priority values. Although these mappings are standardized, not all edge equipment may provide such mapping, and specifying both types of QoS mechanisms gives the federate 10 finer control.

As signaling-based QoS mechanisms, such as those provided by RSVP, for example, permit a fine-grain control over channels, if the QoS tuple associated with a variable indicates that the variable is aggregatable with one or more other variables, the variable can be treated accordingly to permit efficient use of access networks, and to improve a precision with which QoS properties can be specified.

If only one type of QoS mechanism is in place, which type is, is determined in step 116. If only signaling-based QoS mechanisms are supported, the resource reservation protocol (RSVP), for example, is used to create the access network reserved channels, and the edge equipment is required to map the reservation to a priority value for transmission over the network backbone. This mapping, as noted above, has been standardized.

If it is determined in step 116 that only priority-based QoS mechanisms are supported, the packet priority value is retrieved from the QoS tuple, and inserted into each protocol data unit sent. Some access networks (for example, Ethernet 802.1p networks) support priority-based QoS mechanisms, consequently a guarantee of service can be provided without the use of signaling-based QoS mechanisms.

As will be understood by those skilled in the art, network policies used to manage network flow are relevant to a selection of packet priority. Further, depending on the network policies, a current network load may also impact a cost of providing a predefined QoS. The purpose of the QoS tuple is to identify the delivery requirements for the associated variable. Runtime procedures are used to meet these requirements as efficiently as possible. Accordingly, in some cases, prior to the session, a test of the QoS properties as a function of priority value can be run to determine an approximate level of service expected for respective protocol data units. Some network service providers publish guarantees of the QoS properties, and these can be used to select levels with comparison to the values of respective QoS tuples associated with respective instantiated object attributes and interactions.

FIG. 6 illustrates a typical network configuration for interconnecting two federates that are part of a wide-area scale federation. Federate 1 uses an Ethernet 802.1p access network 60 to gain entry to the ATM backbone 64, whereas Federate 2 uses an access network that does not support priority-based QoS mechanisms, but does support integrated services QoS. The ATM backbone 64 includes a plurality of autonomous systems (ASs 1-5) that are interconnected core routers (CRs 66). The access networks connect to bridge routers (BRs 68) of the ATM backbone, via edge routers 70.

Because of the Ethernet QoS mechanisms available to Federate 1, Federate 1 will only use priority-based signaling, while Federate 2 may use both, or only signaling-based QoS mechanisms, depending on a desired reliance on the edge router (ER 2) to map RSVP reservations to priority values.

The invention therefore provides RTI middleware that supports real-time wide-area DIVS. This enables wide-area simulations, as well as remote control of critical processes such as remote control surgery, aircraft piloting, hazardous procedures, etc., none of which could be reliably or safely practiced using known RTI middleware without a dedicated network.

The embodiments of the invention described above are intended to be exemplary only. The scope of the invention is therefore intended to be limited solely by the scope of the appended claims.

I claim:

1. A runtime infrastructure (RTI) middleware for providing a distributed interactive virtual system (DIVS) federate with access to other federates of DIVS, the RTI middleware comprising a library of resources for enabling a standards-based interface between the federates, the library of resources including resources that define classes of virtual objects maintained by the federates, and classes of interactions supported by the federates, the RTI middleware comprising:
a quality of service (QoS) tuple extension to columns of the object class attribute table and to columns of the interaction class parameter table, the QoS tuple extension specifying transport requirements associated with the respective object attributes and the respective interactions.

2. A RTI middleware as claimed in claim 1 wherein the QoS tuple further includes a task priority value that is used to provide priority-based preemptive scheduled processing.

3. A RTI middleware as claimed in claim 1 wherein the QoS tuple includes a value indicating a maximum acceptable loss ratio of data protocol units that identifies a reliability transport requirement.

4. A RTI interface as claimed in claim 1 wherein the QoS tuple includes a value indicating a maximum acceptable latency of data protocol units that identifies a latency transport requirement.

5. A RTI interface as claimed in claim 1 wherein the QoS tuple includes a value indicating an average data transmission rate for reserving network bandwidth, and a value indicating a maximum transmission rate and a duration of the maximum transmission rate for reserving buffer memory in the network.

6. A RTI middleware as claimed in claim 1 further adapted to use the QoS tuple to specify one of a plurality of predefined transport types for transporting variables associated with the respective attributes and interactions.

7. A RTI middleware as claimed in claim 3 further adapted to access a configuration file that specifies a set of available QoS mechanisms and features that may be applied to satisfy the respective transport types for transporting variables associated with the respective attributes and interactions specified by the QOS tuple.

8. A RTI middleware as claimed in claim 7 further adapted to use an application programming interface (API) to create a network channel using resource reservation protocol (RSVP), the network channel having transport properties prescribed by the QoS tuple.

9. A RTI middleware as claimed in claim 8 further adapted to insert a packet priority value into a header of each protocol data unit sent, the packet priority value being specified by the QoS tuple.

10. A RTI interface as claimed in claim 9 wherein the packet priority value is read from the QoS tuple.

11. A RTI interface as claimed in claim 9 wherein the packet priority value is derived from a comparison between the transport requirements in the QoS tuple and a set of QoS properties associated with transmission of protocol data units of respective priorities.

12. A RTI interface as claimed in claim 11 wherein the set of QoS properties are published by a network service provider.

13. A RTI interface as claimed in claim 11 wherein the set of QoS properties are determined empirically prior to commencement of a federation session.

14. A RTI middleware as claimed in claim 1 wherein the library resources comprise a plurality of modules of computer code that perform interface operations between the federates, and each of these modules is assigned a task priority specified by the QoS tuple associated with each object class and each interaction, the respective task priorities being used to control access to computational resources when the federate is supported by a priority-based preemptive scheduled computer operating system.

15. A method for enabling real-time data exchange between federates of a wide-area distributed interactive virtual system, comprising steps of:
extending an object class attribute table and an interaction class parameter table associated with a runtime interface (RTI) middleware used to support the federate, by adding a QoS tuple to the respective tables;
using the QoS tuple to establish a network data transport for respective ones of data variables published by the federate; and
using the QoS tuple to set a priority for access to computational resources of priority-based preemptive scheduled computer operating system used to support the federate.

16. A method as claimed in claim 15 wherein the step of using the QoS tuple to establish a network data transport further comprises a step of accessing a predefined file identifying QoS mechanisms and properties available for establishing the network transport.

17. A method as claimed in claim 16 wherein the step of using the QoS tuple to establish a network data transport comprises a step of reserving and establishing a channel using a signaling-based QoS mechanism.

18. A method as claimed in claim 17 wherein the step of using the QoS tuple to establish a network data transport further comprises a step of determining whether data associated with one object class attribute can be aggregated with data associated with another object class attribute.

19. A method for providing a real-time distributed interactive virtual system (DIVS), comprising steps of:
associating a priority value with each variable maintained by a federate of the DIVS;
using priority-based preemptive scheduled processing to provide differentiated access to computer processing time in accordance with the priority of the variable being processed; and
retrieving quality of service (QoS) descriptors associated with a class of each of the respective variables to provide differentiated access to transport services having respective QoS properties to transport data between federates in the DIVS.

20. A method as claimed in claim 19 wherein the step of associating a priority value further comprises a step of:
extending an object class attribute table and an interaction table associated with a runtime interface (RTI) middleware used to support the federate, by adding a QoS tuple to each of the object class attributes in the object class table and to each interaction in the interactions table.

21. A method as claimed in claim 20 wherein the step of extending the object class table and the interaction table comprises a step of adding columns to the respective tables to specify quality of service parameters for data transport of the variables, and priority values for governing the priority-based preemptive scheduled processing associated with each object class attribute.

22. A method as claimed in claim 19 wherein the step of using priority-based preemptive scheduled processing further comprises steps of:
referencing a one of the attribute table and the interaction table to extract a priority value from the QoS tuple each time a thread or a process is created by the RTI middleware; and
associating the priority value with the thread or process to be executed by the computer operating system, to ensure that the thread or process is executed in accordance with the priority-based preemptive scheduled processing.
